(19) United States
(12) Patent Application Publication
(10) Pub. No.: US 2020/0040655 A1
(43) Pub. Date: Feb. 6, 2020

(54) RESISTANCE MECHANISM FOR CORD OF WINDOW COVERING

(71) Applicant: Nien Made Enterprise Co., Ltd., Taichung (TW)

(72) Inventors: Lin Chen, Taichung (TW); Keng-Hao Nien, Taichung (TW)

(21) Appl. No.: 16/052,628

(22) Filed: Aug. 2, 2018

(51) Int. Cl. E06B 9/322; B65H 75/44

(52) U.S. Cl. CPC E06B 9/322; E06B 2009/3222; B65H 75/4439; B65H 75/446

(57) ABSTRACT

A resistance mechanism is adapted to provide frictional resistance to a cord of a window covering. The resistance mechanism includes a bias member and a resistance assembly adjacent to the cord. The resistance assembly can be operated by the movement of the cord synchronously. The resistance assembly is corresponding to the bias member, and when the cord is moved in a retrieved direction or a released direction, the bias member suppresses a movement of the resistance assembly, and thereby the resistance assembly provides a resistance to the cord. When the cord is pulled in the retrieved direction, the bias member provides a first frictional resistance to the resistance assembly; when the cord is pulled in a released direction, the bias member provides a second frictional resistance to the resistance assembly, and the second frictional resistance is different from the first frictional resistance.

### BACKGROUND OF THE INVENTION

### 1. Field of the Invention

The present disclosure relates generally to a resistance mechanism for opening and closing a window covering, and more particularly to a resistance mechanism providing a resistance force to a cord of the window covering.

### 2. Description of the Prior Art

A conventional cordless window covering includes a headrail, a bottom rail, and a covering material. The bottom rail is positioned under the headrail, and the covering material is positioned between the headrail and the bottom rail. In addition, a spring box is usually used as a driving module in the conventional cordless window covering for retrieving or releasing a cord, and is usually positioned in the headrail. The spring box includes a reel, a driving wheel, and a spiral spring, wherein the reel meshes with the driving wheel, and one end of the spiral spring is fixedly connected to the driving wheel. One end of the cord is connected to the reel, and the other end thereof is connected to the bottom rail after passing through the covering material.

When the bottom rail is pulled away from the headrail to unfold the covering material, the cord would be released from the reel by the movement of the bottom rail, and the reel would be rotated by the movement of the cord simultaneously. At the same time, the reel drives the driving wheel to rotate, so that the spiral spring is wound around the driving wheel, and thereby to store energy. In contrast, when the bottom rail is pushed toward the headrail to fold the covering material, the rewinding force from the spiral spring would drive the driving wheel to rotate, and thereby to drive the reel to reel in the cord.

Besides, once the pushing force (or the pulling force) applied to the bottom rail is removed, the bottom rail could stay at where it is through the balance among the weights of the bottom rail and the covering material, the rewinding force from the spiral spring, and the friction between the cord and other components of the window covering. However, in the conventional cordless window covering, the values of the weights of the bottom rail and the covering material and the rewinding force from the spiral spring could be only approximately estimated, but not accurately measured. Therefore, in practice, it's common for cordless window coverings to have the problem that the rewinding force provided by the spiral spring is too strong or too weak. For example, if the rewinding force from the spiral spring is too strong, it would be not easy to pull down the bottom rail, unfolding the covering material. Or, in the case that the rewinding force from the spiral spring is too strong and the weights of the bottom rail and the covering material are too light in comparison, the bottom rail would be gradually elevated by the rewinding force, and could not stay at a lower position for a long time. On the other hand, if the rewinding force from the spiral spring is too weak, it would be not easy to push the bottom rail upward to fold the covering material. Or, in the case that the weights of the bottom rail and the covering material are too heavy in comparison, the rewinding force from the spiral spring might not be sufficient to withstand the weights, so that the bottom rail would gradually descend due to the weights of the bottom rail and the covering material, and could not stay at a higher position for a long time.

Therefore, it is a problem needs to be solved that how to make the bottom rail of the cordless window covering easy to move, and easy to stay at a desired position.

### SUMMARY OF THE INVENTION

In view of the above, the primary objective of the present invention provides a resistance mechanism for a cord of a window covering. When the cords of the window covering are pulled indifferent directions, a bias member would provide different levels of frictional resistance to a resistance assembly.

To achieve the above objective, the present invention provides a resistance mechanism adapted to provide frictional resistance to a cord of a window covering. Along with a raising and lowering of the window covering, the cord is driven to move in a retrieved direction and a released direction, respectively. The resistance mechanism includes a bias member and a resistance assembly. The resistance assembly is adjacent to the cord, and a section of the cord corresponding to the resistance assembly is wound around the resistance assembly, so that the resistance assembly could be operated by the movement of the cord synchronously. The resistance assembly is corresponding to the bias member. When the cord is moved in the retrieved direction or the released direction, the bias member would suppress a movement of the resistance assembly, whereby the resistance assembly provides a resistance to the cord. When the cord is pulled in the retrieved direction, the bias member provides a first frictional resistance to the resistance assembly; when the cord is pulled in the released direction, the bias member provides a second frictional resistance to the resistance assembly, and the second frictional resistance is different from the first frictional resistance.

In an embodiment, the resistance assembly includes a resistance wheel, and the section of the cord wound around the resistance assembly is tightly wound around the resistance wheel, whereby the resistance wheel could be driven by the cord to rotate. When the cord is pulled in the retrieved direction, the resistance wheel rotates in a first direction; when the cord is pulled in the released direction, the resistance wheel rotates in a second direction, and the second direction is opposite to the first direction.

In an embodiment, the resistance assembly further includes a base, on which the resistance wheel and the bias member are positioned, and the resistance wheel could rotate relative to the base.

In an embodiment, the base has an accommodating space, in which the resistance wheel and the bias member are positioned.

In an embodiment, the bias member and a part of walls of the accommodating space together form a wedge area having a narrow side and a broad side; the resistance wheel is movably positioned in the wedge area, and is operably moved between the narrow side and the broad side.

In an embodiment, when the cord is pulled in the retrieved direction, the resistance wheel is drawn by the cord to move toward the narrow side, and thereby the bias member abuts against the resistance wheel to suppress a rotation of the resistance wheel, whereby to provide the first frictional resistance; when the cord is pulled in the released direction, the resistance wheel is drawn by the cord to move toward the broad side, and at this time, the resistance wheel optionally contacts the bias member, whereby to provide the second frictional resistance, and the second frictional resistance is less than the first frictional resistance.

In an embodiment, when the cord is pulled in the retrieved direction, the resistance wheel is drawn by the cord to move toward the broad side, and at this time, the resistance wheel optionally contacts the bias member, whereby to provide the first frictional resistance; when the cord is pulled in the released direction, the resistance wheel is drawn by the cord to move toward the narrow side, and thereby the bias member abuts against the resistance wheel to suppress a rotation of the resistance wheel, whereby to provide the second frictional resistance; and the second frictional resistance is greater than the first frictional resistance.

In an embodiment, the bias member has a bent section close to the narrow side of the wedge area; when the resistance wheel is pulled by the cord to move toward the narrow side, the bent section of the bias abuts against the resistance wheel, so as to suppress the rotation of the resistance wheel, and thereby a rotation speed of the resistance wheel becomes slower.

In an embodiment, the bias member has an abutting portion optionally abutting one of the walls of the accommodating space; the bias member includes a free end, which is not at the abutting portion, and is close to the broad side of the wedge area.

In an embodiment, the bias member includes a constraint portion and an abutting portion. The abutting portion abuts against a wall of the accommodating space, and the constraint portion is drivable by the abutting portion to optionally release or grip the resistance wheel, whereby to allow or disallow the resistance wheel to rotate relative to the constraint portion.

In an embodiment, a winding direction of the constraint portion of the bias member around the resistance wheel is same as a winding direction of the cord around the resistance wheel; when the cord is pulled in the retrieved direction, the resistance wheel could be driven to rotate in the first direction, and the abutting portion of the bias member would abut against the wall, so that the bias member cannot move; at this time, the rotation of the resistance wheel could make the constraint portion to be slightly released, and therefore the resistance wheel could rotate relative to the bias member, whereby the constraint portion provides the first frictional resistance to the resistance wheel, suppressing the rotation of the resistance wheel; when the cord is pulled in the released direction, the resistance wheel could be driven by the cord to rotate in the second direction, and the constraint portion grips the resistance wheel, so that the resistance wheel drives the bias member to rotate together; at this time, the abutting portion of the bias member is driven to optionally rub the wall of the base, whereby the bias member optionally provides the second frictional resistance to the base, and the second frictional resistance is less than the first frictional resistance.

In an embodiment, a winding direction of the constraint portion of the bias member around the resistance wheel is opposite to a winding direction of the cord around the resistance wheel; when the cord is pulled in the retrieved direction, the resistance wheel could be driven to rotate in the first direction, and the bias member grips the resistance wheel, so that the resistance wheel drives the bias member to rotate together; at this time, the abutting portion of the bias member is driven to optionally rub the wall of the base, whereby the bias member optionally provides the first frictional resistance to the base; when the cord is pulled in the released direction, the resistance wheel could be driven by the cord to rotate in the second direction, and the abutting portion of the bias member would abut against the wall, so that the bias member cannot move; at this time, the rotation of the resistance could make the constraint portion to be slightly released, and therefore the resistance wheel could rotate relative to the bias member, whereby the constraint portion provide the second frictional resistance to the resistance wheel, suppressing the rotation of the resistance wheel, and the second frictional resistance is greater than the first frictional resistance.

In embodiments of the present invention, the bias member is a coiled spring, and a diameter of the constraint portion is less than a diameter of the abutting portion.

With the aforementioned designs, the resistance assembly would be affected by the bias member when the cord is being retrieved or released. Furthermore, the resistance assembly could provide different strengths of frictional resistance to the resistance member.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will be best understood by referring to the following detailed description of some illustrative embodiments in conjunction with the accompanying drawings, in which:

FIG. 1 is a perspective view of a cordless window covering applied with the concept of the present invention;

FIG. 2 is a perspective view of a spring box according to a first embodiment of the present invention;

FIG. 3 is a front view of the spring box according to the first embodiment of the present invention, wherein a cord is moved in a released direction;

FIG. 4 is a sectional view along the 4-4 line in FIG. 3, wherein the cord is moved in the released direction;

FIG. 5 is a see-through bottom view of the right side of the spring box in FIG. 3, wherein an elastic chip and an axle of a friction wheel are expressed in solid lines, while other components are drawn in dashed lines;

FIG. 6 is another front view of the spring box according to the first embodiment of the present invention, wherein a cord is moved in a retrieved direction;

FIG. 7 is a sectional view along the 7-7 line in FIG. 6, wherein the cord is moved in the retrieved direction;

FIG. 8 is a see-through bottom view of the right side of the spring box in FIG. 6, wherein an elastic chip and an axle of a friction wheel are expressed in solid lines, while other components are drawn in dashed lines;

FIG. 9 is a front view of a spring box according to a second embodiment of the present invention, wherein a cord is moved in a released direction;

FIG. 10 is a sectional view along the 10-10 line in FIG. 9, wherein the cord is moved in the released direction;

FIG. 11 is a see-through bottom view of the right side of the spring box in FIG. 9, wherein an elastic chip and an axle of a friction wheel are expressed in solid lines, while other components are drawn in dashed lines;

FIG. 12 is another front view of the spring box according to the second embodiment of the present invention, wherein a cord is moved in a retrieved direction;

FIG. 13 is a sectional view along the 13-13 line in FIG. 12, wherein the cord is moved in the retrieved direction;

FIG. 14 is a see-through bottom view of the right side of the spring box in FIG. 12, wherein an elastic chip and an axle of a friction wheel are expressed in solid lines, while other components are drawn in dashed lines;

FIG. 15 is a perspective view of a spring box according to a third embodiment of the present invention;

FIG. 16 is a front view of the spring box according to the third embodiment of the present invention;

FIG. 17 is a sectional view along the 17-17 line in FIG. 16;

FIG. 18 is a partial exploded view of the spring box according to the third embodiment of the present invention, wherein friction wheels, coiled springs and a base are shown in an exploded manner;

FIG. 19 is a top view of the right side of the base in FIG. 18, showing a wall and an accommodating space of the base;

FIG. 20 is a top view of the base in FIG. 19, which is combined with the coiled spring, wherein the coiled spring is positioned in the accommodating space;

FIG. 21 is a partial sectional view along the 21-21 line in FIG. 17;

FIG. 22 is a partial sectional view along the 22-22 line in FIG. 16;

FIG. 23 is a front view of a spring box according to a fourth embodiment of the present invention;

FIG. 24 is a partial sectional view along the 24-24 line in FIG. 23;

FIG. 25 is a partial exploded view of a spring box according to a fifth embodiment of the present invention, wherein friction wheels, coiled springs and a base are shown in an exploded manner;

FIG. 26 is a top view of the right side of the base in FIG. 25, showing a wall and an accommodating space of the base; and

FIG. 27 is a top view of the base in FIG. 26, which is combined with the coiled spring, wherein the coiled spring is positioned in the accommodating space.

### DETAILED DESCRIPTION

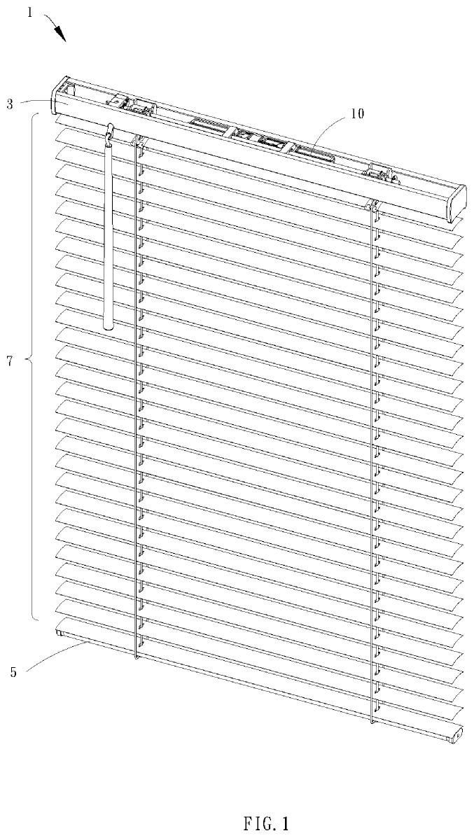

For easily understanding the present invention, several embodiments and accompanying drawings are illustrated as the following. A cordless window covering 1 applied with the concept of the present invention is shown in FIG. 1, including a headrail 3, a bottom rail 5, and a covering material 7, wherein the bottom rail 5 is under the headrail 3, and the covering material 7 is between the headrail 3 and the bottom rail 5. In FIG. 1, the covering material 7 is represented by a covering structure formed by a plurality of slats which are arranged in intervals; however, in practice, the covering material 7 can also be a covering structure formed by one layer or multilayer of foldable sheets.

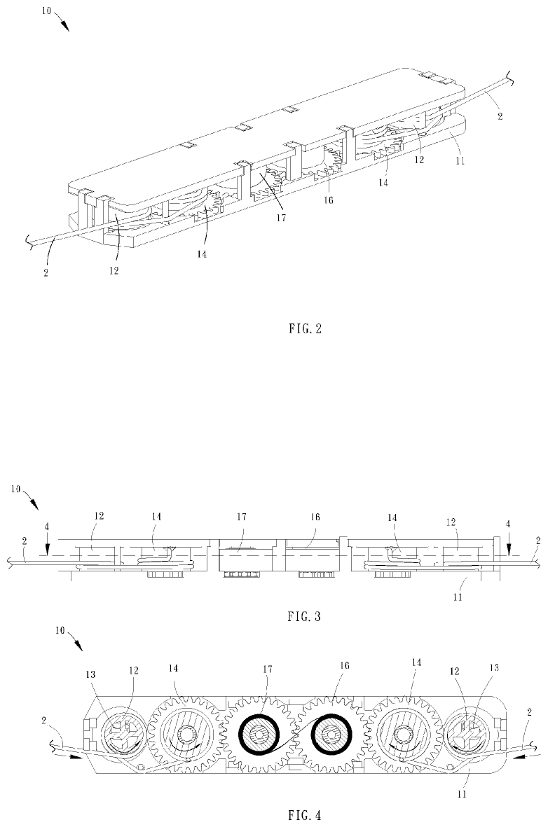

A spring box 10 is shown in FIG. 2 to FIG. 7, which is adapted to be a driving module in the cordless window covering 1 for winding up or releasing a cord 2, and is positioned in the headrail 3. The spring box 10 includes a friction wheel 12, a reel 14, a driving wheel 16, and a spiral spring 17, wherein the reel 14 and the driving wheel 16 mesh with each other, and one end of the spiral spring 17 is fixedly connected to the driving wheel 16. The cord 2 has one end connected to the reel 14, and the other end thereof passes through the covering material 7 to connect to the bottom rail 5. In addition, a part of the cord 2 is adjacent to the friction wheel 12, and is tightly wound around the friction wheel 12. More specifically, since the two ends of the cord 2 are respectively connected to the reel 14 and the bottom rail 5, and are tensioned, the cord 2 could be tightly wound around the friction wheel 12. Unless the cord 2 is pulled in a retrieved direction or a released direction, the friction 12 would not be driven by the cord 2 to rotate; if the cord 2 remains still, the friction wheel 12 would be also still.

When the bottom rail 5 is pulled away from the head rail 3 to unfold the covering material 7, the cord 2 is driven by the bottom rail 5 to release from the reel 14, and the reel 14 rotates along with the movement of the cord 2. At the same time, the reel 14 drives the driving wheel 16 to rotate, and thereby the spiral spring 17 is being wound around the driving wheel 16 to store energy. On the other hand, when the bottom rail 5 is pushed toward the headrail 3 to fold the covering material 7, the rewinding force from the spiral spring 17 could drive the driving wheel 16 to rotate, whereby to drive the reel 14 to wind up the cord 2.

As shown in FIG. 2 to FIG. 8, the spring box 10 further includes a base 11 and two bias members 13. The friction wheel 12, the bias member 13 and the reel 14 are positioned on the base 11, wherein the friction wheel 12 and the reel 14 could operably rotate relative to the base 11. The base 11 has a plurality of walls 112, and the walls 112 are arranged in a way that forms an enclosed accommodating space 113. Furthermore, an axle 121 of the friction wheel 12 and the bias member 13 are positioned in the accommodating space 113.

In the current embodiment, the bias member 13 is an elastic chip including a first end 131, a second end 133, and a bent section 134. The first end 131 could be fixed on or movably abut against one of the walls 112 of the base 11. In practice, the first end 131 could also optionally abut against any one of the internal corners of the accommodating space 113.

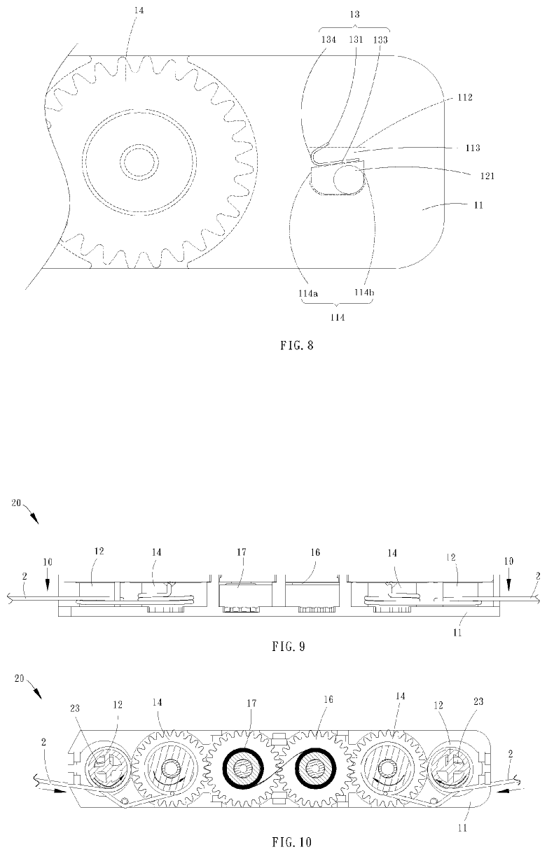

In FIG. 5 and FIG. 8, the elastic chip 13 and a part of the walls 112 of the base 11 form a wedge area 114 together. The wedge area 114 has a narrow side 114a and a broad side 114b. The axle 121 of the friction wheel 12 is positioned in the wedge area 114, and is operably moved between the narrow side 114a and the broad side 114b. The bent section 134 of the elastic chip 13 is close to the narrow side 114a of the wedge area 114, but is away from the broad side 114b thereof. The second end 133 of the elastic chip 13 is a free end, which is close to the broad side 114b of the wedge area 114, but away from the narrow side 114a thereof. However, in practice, the bias member 13 is not limited to be the elastic chip, any objects which can together form the wedge area 114 in the accommodating space 113 would be applicable. Preferably, the bias member 13 should have an elastic portion close to the narrow side 114a of the wedge area 114, whereby the axle 121 of the friction wheel 12 could be abutted against by the elastic portion of the member. In addition, the narrow side 114a of the wedge area 114 is close to the reel 14, and the broad side 114b thereof is away from the reel 14; that is, the bent section 134 of the elastic chip 13 is close to the reel 14, and the second end 133 of thereof is away from the reel 14.

The right side of the spring box 10 is shown in FIG. 4 and FIG. 5, wherein the cord 2 is wound around the reel 14 counterclockwise, and is tightly wound around the friction wheel 12. Therefore, when the reel 14 is driven by the driving wheel 16 to wind up the cord 2, the reel 14 rotates clockwise, and the cord 2 would draw the friction wheel 12 toward the reel 14 simultaneously, whereby to draw the friction wheel 12 to move toward the narrow side 114a, and therefore the friction wheel 12 is driven by the cord 2 to rotate clockwise. On the other hand, when the axle 121 of the friction wheel 12 is moved to contact the bent section 134 of the elastic chip 13, the bent section 134 of the elastic chip 13 would abut against the axle 121 of the friction wheel 12, whereby to reduce the rotation speed of the friction wheel 12. In other words, when the bent section 134 of the elastic chip 13 abuts against the axle 121 of the friction wheel 12, the elastic chip 13 would provide a first frictional resistance to the axle 121 of the frictional resistance 12, whereby to suppress the rotation of the friction wheel 12.

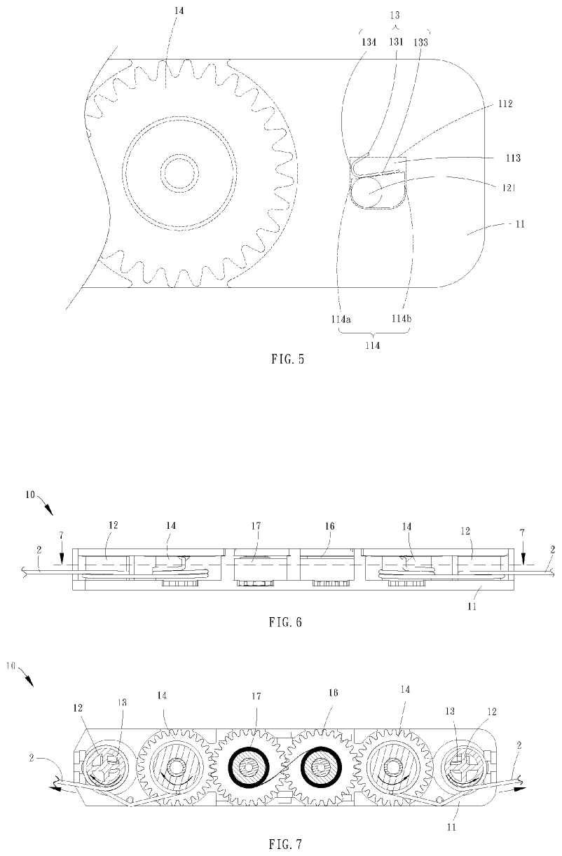

As shown on the right side of FIG. 7 and in FIG. 8, when the bottom rail 5 is pulled to unfold the covering material 7, the cord is released from the reel 14, and the reel 14 rotates counterclockwise. At the same time, the pulling force applied for pulling up the bottom rail 5 through the cord 2 draws the friction wheel 12 to move away from the reel 14, whereby the axle 121 of the friction wheel 12 is driven to move toward the broad side 114b, and the friction wheel 12 is driven by the cord 2 to rotate counterclockwise. On the other hand, the axle 121 of the friction wheel 12 is moved away from the bent section 134 of the elastic chip 13, and thereby the bent section 134 of the elastic chip 13 stops providing the first frictional resistance to the axle 121 of the friction wheel 12. In the current embodiment, when the axle 121 of the friction wheel 12 is moved to the broad side 114b, the second end 133 of the elastic chip 13 could slightly contact the axle 121 of the friction wheel 12, whereby to provide a second frictional resistance to the axle 121 of the friction wheel 12. In addition, the second end 133 of the elastic chip 13 is at the broad side 114b to provide a greater space for the axle 121 of the friction wheel 12, and when the axle 121 of the friction wheel 12 is moved to the broad side 114b, the second end 133 slightly contacts the axle 121 of the friction wheel 12, for the second end 133 does not abut against the wall 112 of the base 11; whereby, the second frictional resistance is far less than the first frictional resistance. However, in practice, when the axle 121 of the friction wheel 12 is moved to the broad side 114b, the axle 121 of the friction wheel 12 could have no contact with the second end 133 of the elastic chip at all, and therefore there would be no frictional resistance generated between the axle 121 of the friction wheel 12 and the second end 133 of the elastic chip; that is, the value of the second frictional resistance would be 0. In this condition, the second frictional resistance is also far less than the first frictional resistance.

When the pulling force applied to the bottom rail 5 is removed after the bottom rail 5 of the cordless window covering 1 is pulled to a predetermined position, the weights of the bottom rail 5 and the covering material 7 could be less than the rewinding force provided by the spiral spring 17, and therefore the bottom rail 5 would be pulled upward. At this moment, the rewinding force from the spiral spring 17 would slightly pull the cord 2 through the reel 14, whereby the cord 2 would draw the friction wheel 12 to move close to the reel 14 until the axle 121 of the friction wheel 12 contacts the bent section 134 of the elastic chip 13, so that the elastic chip 13 could provide frictional resistance to the friction wheel 12. At the same time, the frictional resistance between the friction wheel 12 and the elastic chip 13 could prevent the cord 2 tightly wound around the friction wheel 12 from driving the friction wheel 12 to rotate, whereby to resist the movement of the cord 2, and thereby the frictional resistance could help to counterbalance the weights of the bottom rail 5 and the covering material 7 and the rewinding force from the spiral spring 17, making the bottom rail 5 to stably stay at the predetermined position.

A spring box 20 of a second embodiment of the present invention is shown in FIG. 9 to FIG. 14, which is also applicable to the cordless window covering 1. The spring box 20 is similar to the spring box 10 of the first embodiment. However, the difference between the second embodiment and the first embodiment is that, the arrangement direction of a bias member 23 in the spring box 20 of the second embodiment is different from that in the spring box 10 of the first embodiment.

In the current embodiment, the bias member 23 is an elastic chip including a first end 231, a second end 233, and a bent section 234. The first end 231 could be fixed on or movably abut against one of the walls 112 of the base 11. In practice, the first end 231 could also optionally abut against any one of the internal corners of the accommodating space 113.

As shown in FIG. 11 and FIG. 14, the elastic chip 23 and a part of the walls 112 of the base 11 form a wedge area 214 together, and the wedge area 214 has a narrow side 214a and a broad side 214b. The axle 121 of the friction wheel 12 is positioned in the wedge area 214, and is operably moved between the narrow side 214a and the broad side 214b. The bent section 234 of the elastic chip 23 is close to the narrow side 214a of the wedge area 214, but is away from the broad side 214b thereof. The second end 233 of the elastic chip 23 is a free end, which is close to the broad side 214b of the wedge area 214, but away from the narrow side 214a thereof. In addition, the narrow side 214a of the wedge area 214 is away from the reel 14, and the broad side 214b thereof is close to the reel 14; that is, the bent section 234 of the elastic chip 23 is close to the reel 14, and the second end 233 of thereof is away from the reel 14.

As shown on the right side of FIG. 10 and in FIG. 11, when the reel 14 is driven by the driving wheel 16 to wind up the cord 2, the reel 14 rotates clockwise, and the cord 2 would draw the friction wheel 12 toward the reel 14 simultaneously, whereby to draw the friction wheel 12 to move toward the broad side 214b, and therefore the friction wheel 12 is driven by the cord 2 to rotate clockwise. On the other hand, when the axle 121 of the friction wheel 12 is driven to move toward the broad side 214b, the axle 121 of the friction wheel 12 is moved away from the bent section 234 of the elastic chip 23. In the current embodiment, when the axle 121 of the friction wheel 12 is moved to the broad side 214b, the second end 233 of the elastic chip 23 could slightly contact the axle 121 of the friction wheel 12, whereby to provide a first frictional resistance to the axle 121 of the friction wheel 12. However, in practice, when the axle 121 of the friction wheel 12 is moved to the broad side 214b, the axle 121 of the friction wheel 12 could have no contact with the second end 233 of the elastic chip 23 at all, and therefore there would be no frictional resistance generated between the axle 121 of the friction wheel 12 and the second end 233 of the elastic chip 23; that is, the value of the second frictional resistance would be 0.

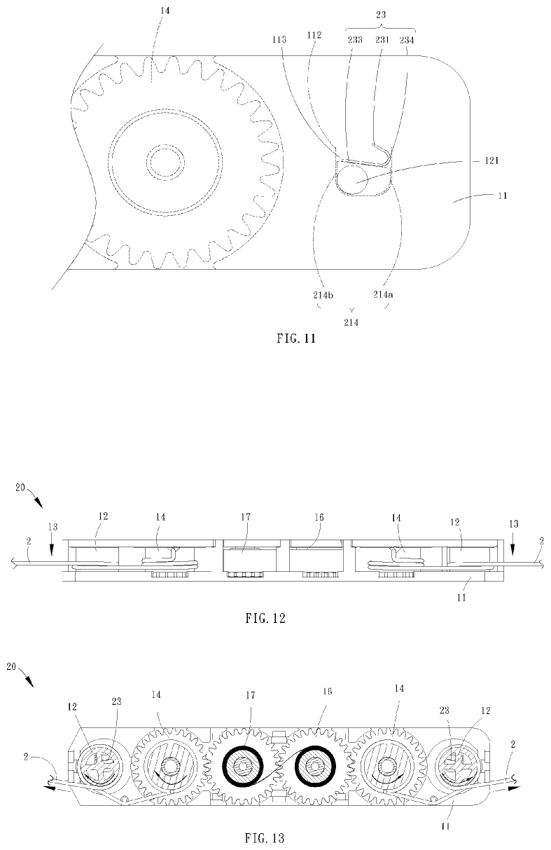

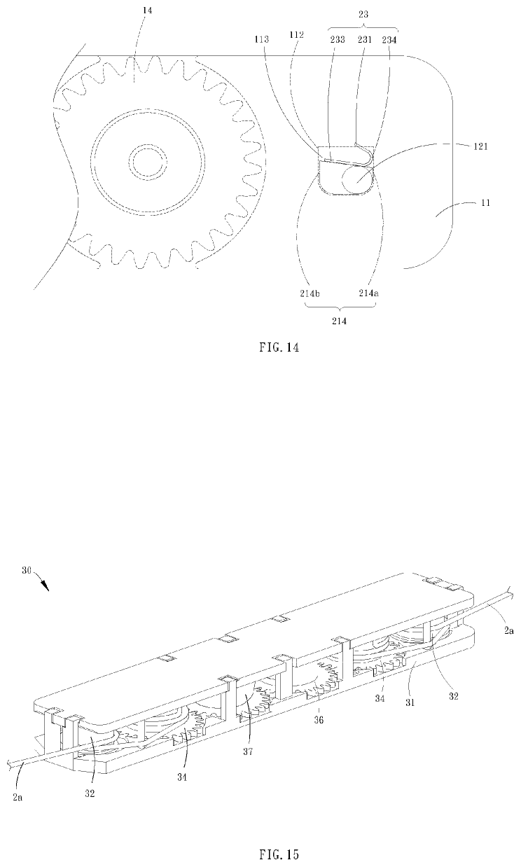

As shown on the right side of FIG. 12 and in FIG. 13, when the bottom rail 5 is pulled to unfold the covering material 7, the cord is released from the reel 14, and the reel 14 rotates counterclockwise. At the same time, the pulling force applied for pulling up the bottom rail 5 through the cord 2 draws the friction wheel 12 to move away from the reel 14, and the friction wheel 12 is driven by the cord 2 to rotate counterclockwise simultaneously. On the other hand, when the axle 121 of the friction wheel 12 is moved to contact the bent section 234 of the elastic chip 23, the bent section 234 of the elastic chip 23 would abut against the axle 121 of the friction wheel 12, whereby to reduce the rotation speed of the friction wheel 12. In other words, when the bent section 234 of the elastic chip 23 abuts against the axle 121 of the friction wheel 12, the elastic chip 23 would provide a second frictional resistance to the axle 121 of the friction wheel 12, whereby to suppress the rotation of the friction wheel 12. In this condition, since the bent section 234 of the elastic chip 23 would abut against the axle 121 of the friction wheel 12, the second frictional resistance would be far greater than the first frictional resistance.

When the pulling force applied to the bottom rail 5 is removed after the bottom rail 5 of the cordless window covering 1 is pushed to a predetermined position, the weights of the bottom rail 5 and the covering material 7 could be greater than the rewinding force provided by the spiral spring 17, and therefore the bottom rail 5 would be dropped downward. At this moment, the weights of the bottom rail 5 and the covering material 7 could drive the reel 14 to rotate counterclockwise through the cord 2, whereby the cord 2 would draw the friction wheel 12 to move away from the reel 14 until the axle 121 of the friction wheel 12 contacts the bent section 234 of the elastic chip 23, so that the elastic chip 23 would provide frictional resistance to the friction wheel 12. At the same time, the frictional resistance between the friction wheel 12 and the elastic chip 23 could prevent the cord 2 tightly wound around the friction wheel 12 from driving the friction wheel 12 to rotate, whereby to resist the movement of the cord 2, and thereby the frictional resistance could help to counterbalance the weights of the bottom rail 5 and the covering material 7 and the rewinding force from the spiral spring 17, making the bottom rail 5 to stably stay at the predetermined position.

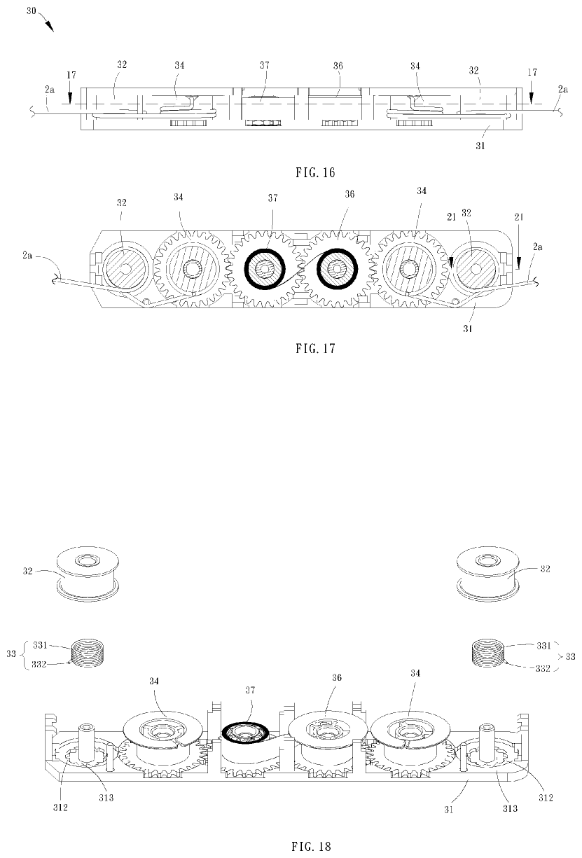

A spring box 30 of a third embodiment of the present invention is shown in FIG. 15 to FIG. 22, which is also applicable to the cordless window covering 1. The spring box 30 includes a friction wheel 32, a reel 34, a driving wheel 36, and a spiral spring 37, wherein the reel 34 and the driving wheel 36 mesh with each other, and one end of the spiral spring 37 is fixedly connected to the driving wheel 36. The cord 2a has one end connected to the reel 34, and another end thereof passes through the covering material 7 to be connected to the bottom rail 5. In addition, a part of the cord 2a is adjacent to the friction wheel 32, and is tightly wound around the friction wheel 32. More specifically, the two ends of the cord 2a are respectively connected to the reel 34 and the bottom rail 5 and are tensioned, so that the cord 2a could be tightly wound around the friction wheel 32. Unless the cord 2a is pulled in the retrieved direction or the released direction, the friction wheel 32 would not be driven by the cord 2a to rotate; if the cord 2a remains still, the friction wheel 32 would be also still.

The spring box 30 further includes abase 31 and two bias members 33. The friction wheel 32, the bias member 33 and the reel 34 are positioned on the base 31, and the friction wheel 32, the bias member 33 and the reel 34 could operably rotate relative to the base 31. The base 31 has a plurality of walls 312, and the walls 312 form an enclosed accommodating space 313. Furthermore, an axle 321 of the friction wheel 32 and the bias member 33 are positioned in the accommodating space 313.

In the current embodiment, the bias member 33 is a coiled spring including a constraint portion 331 and an abutting portion 332 connected to each other. Each wall 312 forms in a ratchet shape, and the abutting portion 332 has a free end optionally abutting against one of the walls 312 of the accommodating space 313.

The constraint portion of the coiled spring 33 is constantly wound around the axle 321 of the friction wheel 32, and the friction wheel 32 could drive the abutting portion 332 to rotate, whereby to drive the constraint portion 331 to rotate along with the abutting portion 332 while the friction wheel 32 is rotating, for the constraint portion 331 and the abutting portion 332 of the coiled spring 33 are connected to each other. In addition, the constraint portion 331 of the coiled spring 33 is operable to optionally grip the axle 321 of the friction wheel 32, and thereby the axle 321 could not rotate relative to the constraint portion 331. By being operated in another way, the axle 321 of the friction wheel 32 could release the constraint portion 331 of the coiled spring 33, and thereby the axle 321 could rotate relative to the abutting portion 332, though the constraint portion 331 still contacts the axle 321.

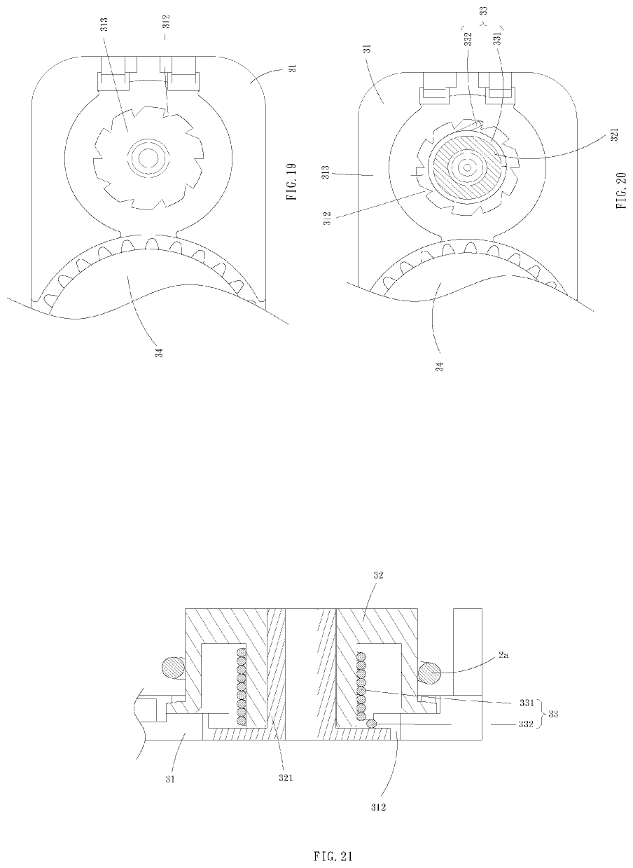

On the right side of the spring box 30 as shown in FIG. 18, and also as illustrated in FIG. 19, FIG. 20 and FIG. 21, the constraint portion 331 of the coiled spring 33 is wound around the axle 321 of the friction wheel 32 counterclockwise from bottom up, and the abutting portion 332 is connected to the bottom end of the constraint portion 331, extending outward from the constraint portion 331. Furthermore, the abutting portion 332 is received in the accommodating space 313, but such arrangement is not a limitation of the present invention. In practice, the abutting portion could also extend inward or downward from the constraint portion, in accordance with the position of the walls 312 of the accommodating space 313. In FIG. 18 and FIG. 21, the abutting portion 332 of the coiled spring 33 is under the constraint portion 331, but this is not a limitation of the present invention. In practice, since the abutting portion 332 corresponds to the accommodating space, the relative positions of the constraint portion 331 and the abutting portion 332 could be modified according to the design of the accommodating space 313. For example, the abutting portion 332 of the coiled spring 33 could be also located above the constraint portion 331, as long as an end of the abutting portion 332 could abut against one of the walls 312 of the accommodating space 313.

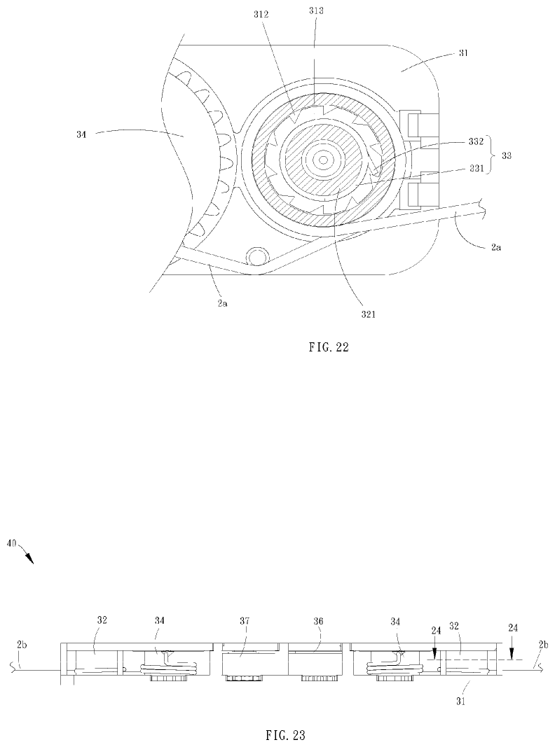

As shown on the right side of FIG. 18 and in FIG. 22, the winding direction of the constraint portion 331 of the coiled spring 33 around the axle 321 of the friction wheel 32 is the same as the winding direction of the cord 2a around the friction wheel 32. When the reel 34 is driven by the driving wheel 36 to wind up the cord 2a, the reel 34 rotates clockwise, and the friction wheel 32 could be driven by the cord 2a to rotate clockwise simultaneously. At the moment, the end of the abutting portion 332 abuts against one of the walls 312 of the accommodating space 313, and thereby the coiled spring 33 could not rotate and move. In addition, the rotation direction of the friction wheel 32 is opposite to the winding direction of the constraint portion 331, which would drive the constraint portion 331 to expand radially, whereby to release the axle 321, so that the friction wheel 32 could rotate relative to the constraint portion 331. However, though the friction wheel 32 is able to rotate relative to the constraint portion 331, the constraint portion 331 still keeps tightly contacting the axle 321 of the friction wheel 32, so that the constraint portion 331 provides a first frictional resistance to the axle 321 of the friction wheel 32, whereby to suppress the rotation of the friction wheel 32.

On the other hand, when the bottom rail 5 is pulled to unfold the covering material 7, the cord 2a is released from the reel 34, and the friction wheel 32 could be driven by the cord 2a to rotate counterclockwise simultaneously. The rotation direction of the friction wheel 32 is the same as the winding direction of the constraint portion around the axle 321, so that the rotation of the friction wheel 32 could make the constraint portion 331 of the coiled spring 33 to grip the axle 321 of the friction wheel 32, and thereby both of them would not rotate relative to each other. Furthermore, the friction wheel 32 could drive the coiled spring 33 to rotate counterclockwise along with the movement of the cord 2a. In this condition, the abutting portion 332 of the coiled spring 33 could rotate along with the rotation of the constraint portion 331, and rub the wall 312 of the base 31, whereby the coiled spring 33 provides a second frictional resistance to the base 31. The second frictional resistance is far less than the first frictional resistance, for the abutting portion 332 of the coiled spring 33 only slightly abuts against the walls 312 of the base 31.

When the pulling force applied to the bottom rail 5 is removed after the bottom rail 5 of the cordless window covering 1 is pulled down to a predetermined position, the weights of the bottom rail 5 and the covering material 7 could be less than the rewinding force provided by the spiral spring 37, and therefore the bottom rail 5 would be pulled upward. At this moment, the rewinding force from the spiral spring 37 could pull the cord 2a through the reel 34, whereby the cord 2a could drive the friction wheel 32 to rotate clockwise, and the rotation of the friction wheel 32 would drive the constraint portion 331 of the coiled spring 33 to expand slightly, and thereby the frictional resistance generated between the coiled spring 33 and the friction wheel 32 suppresses the rotation of the friction wheel 32. At the same time, when the rotation of the friction wheel 32 gets suppressed, the cord 2a tightly wound around the friction wheel 32 does not easily drive the friction wheel 32 to rotate, whereby to resist the movement of the cord 2a, and thereby the frictional resistance could help to counterbalance the weights of the bottom rail 5 and the covering material 7 and the rewinding force from the spiral spring 37, making the bottom rail 5 to stably stay at the predetermined position.

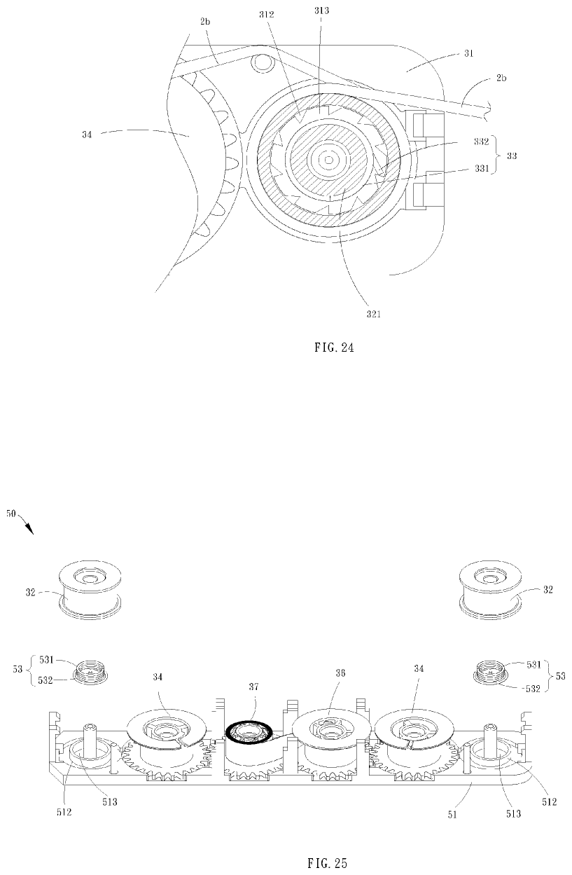

A spring box 40 of a fourth embodiment of the present invention is shown in FIG. 23 to FIG. 24, which is also applicable to the cordless window covering 1. The spring box 40 is similar to the spring box 20 of the third embodiment. However, the difference between the fourth embodiment and the third embodiment is that, the winding direction that a cord 2b winding around the friction wheel 32 in the fourth embodiment is different from that of the cord 2a in the third embodiment.

In FIG. 24, the winding direction of the constraint portion 331 of the coiled spring 33 around the axle 321 of the friction wheel 32 is opposite to the winding direction of the cord 2b around the friction wheel 32. When the reel 34 is driven by the driving wheel 36 to wind up the cord 2b, the reel 34 rotates counterclockwise, and the friction wheel 32 could be driven by the cord 2b to rotate counterclockwise simultaneously. At the moment, the rotation direction of the friction wheel 32 is the same as the winding direction of the constraint portion around the axle 321, so that the friction wheel 32 could drive the coiled spring 33 to rotate counterclockwise together, but the friction wheel 32 could not rotate relative to the coiled spring 33. In this condition, the abutting portion 332 of the coiled spring 33 could rotate along with the rotation of the constraint portion 331, and rub the wall 312 of the base 31, whereby the coiled spring 33 provides a first frictional resistance to the base 31.

On the other hand, when the bottom rail 5 is pulled downward to unfold the covering material 7, the cord 2b is released from the reel 34, and the reel 34 rotates clockwise. At the same time, the friction wheel 32 could be driven by the cord 2b to rotate clockwise. At the moment, the end of the abutting portion 332 abuts against one of the walls 312 of the accommodating space 313, and thereby the coiled spring 33 could not rotate and move. In addition, the rotation direction of the friction wheel 32 is opposite to the winding direction of the constraint portion 331, which would drive the constraint portion 331 to expand radially, whereby to release the axle 321, so that the friction wheel 32 could rotate relative to the constraint portion 331. However, though the friction wheel 32 is able to rotate relative to the constraint portion 331, the constraint portion 331 still keeps tightly contacting the axle 321 of the friction wheel 32, so that the constraint portion 331 provides a second frictional resistance to the axle 321 of the friction wheel 32, whereby to suppress the rotation of the friction wheel 32. In this condition, though the friction wheel 32 is able to rotate relative to the constraint portion 331, the constraint portion 331 still keeps tightly contacting the axle 321 of the friction wheel 32, so that the second frictional resistance is far greater than the first frictional resistance.

When the pulling force applied to the bottom rail 5 is removed after the bottom rail 5 of the cordless window covering 1 is pushed to a predetermined position, the weights of the bottom rail 5 and the covering material 7 could be greater than the rewinding force from the spiral spring 37, and therefore the bottom rail 5 would be dropped downward. At this moment, the weights of the bottom rail 5 and the covering material 7 could pull the cord 2b to release from the reel 34, whereby the cord 2b drives the friction wheel 32 to rotate clockwise; the rotation of the friction wheel 32 would drive the constraint portion 331 of the coiled spring 33 to expand slightly, but the constraint portion 331 still lightly contacts the axle 321 of the friction wheel 32, and thereby the frictional resistance generated between the coiled spring 33 and the friction wheel 32 suppresses the rotation of the friction wheel 32. At the same time, when the rotation of the friction wheel 32 is suppressed, the cord 2b tightly wound around the friction wheel 32 does not easily drive the friction wheel 32 to rotate, whereby to resist the movement of the cord 2b, and thereby the frictional resistance could help to counterbalance the weights of the bottom rail 5 and the covering material 7 and the rewinding force from the spiral spring 37, making the bottom rail 5 to stably stay at the predetermined position.

A spring box 50 of a fifth embodiment of the present invention is shown in FIG. 25 to FIG. 27, which is also applicable to the cordless window covering 1. The spring box 50 is similar to the spring box 30 of the third embodiment. However, the difference between the fifth embodiment and the third embodiment is that, the shapes of a bias member 53 and an accommodating space 513 in the fifth embodiment are different from the shapes of a bias member 33 and an accommodating space 313 in the third embodiment. In the fifth embodiment, the accommodating space 513 is in a circular shape, and the bias member 53 is a coiled spring, which can be roughly divided into a constraint portion 531 and an abutting portion 532 connected to each other, wherein the abutting portion 532 constantly abuts against a wall 512 of the accommodating space 513.

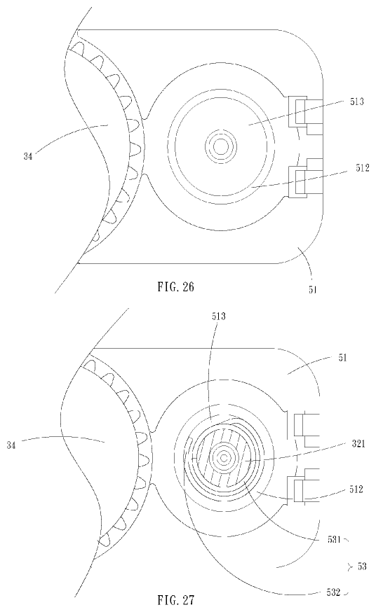

In the right side of the spring box 50 as shown in FIG. 25, and as illustrated in FIG. 26 and FIG. 27, the constraint portion 531 of the coiled spring 53 is wound around the axle 321 of the friction wheel 32 counterclockwise from bottom up, and the abutting portion 532 is connected to the bottom end of the constraint portion 531, and is in the accommodating space 513 counterclockwise. In the current embodiment, the diameter of the constraint portion 531 of the coiled spring 53 is less than the diameter of the abutting portion 532, but this is not a limitation of the present invention. In practice, the diameter of the constraint portion could also be equal to or greater than the diameter of the abutting portion, in accordance with the position of the wall 512 of the accommodating space 513.

As shown on the right side of FIG. 25 and in FIG. 27, when the friction wheel 32 could be driven by the cord to rotate clockwise, the abutting portion 532 abuts against one of the wall 512 of the accommodating space 513, and thereby the coiled spring 53 could not rotate and move. In addition, the rotation direction of the friction wheel 32 is opposite to the winding direction of the constraint portion 531, which would drive the constraint portion 531 to expand radially, whereby to release the axle 321, so that the friction wheel 32 could rotate relative to the constraint portion 531. However, though the friction wheel 32 is able to rotate relative to the constraint portion 531, the constraint portion 531 still keeps tightly contacting the axle 321 of the friction wheel 32, so that the constraint portion 531 provides a first frictional resistance to the axle 321 of the friction wheel 32, whereby to suppress the rotation of the friction wheel 32.

On the other hand, when the friction wheel 32 is driven by the cord to rotate counterclockwise, the rotation direction of the friction wheel 32 is the same as the winding direction of the constraint portion 531 around the axle 321, so that the rotation of the friction wheel 32 could make the constraint portion 531 of the coiled spring 53 to grip the axle 321 of the friction wheel 32, and thereby both of them would not rotate relative to each other. Furthermore, the friction wheel 32 could drive the coiled spring 53 to rotate counterclockwise. In this condition, the abutting portion 532 of the coiled spring 53 could rotate along with the rotation of the constraint portion 531, and rub the wall 512 of the base 51, whereby the coiled spring 53 provides a second frictional resistance to the base 51. The second frictional resistance is far less than the first frictional resistance, for the abutting portion 532 of the coiled spring 53 only slightly abuts against the wall 512 of the base 51.

When the pulling force applied to the bottom rail 5 is removed after the bottom rail 5 of the cordless window covering 1 is pulled to a predetermined position, the weights of the bottom rail 5 and the covering material 7 could be less than the rewinding force from the spiral spring 37, and therefore the bottom rail 5 would be pulled upward. At this moment, the rewinding force from the spiral spring 37 could pull the cord through the reel 34, whereby the cord could drive the friction wheel 32 to rotate clockwise, and the rotation of the friction wheel 32 would drive the constraint portion 531 of the coiled spring 53 to expand slightly, and thereby the frictional resistance generated between the coiled spring 53 and the friction wheel 32 suppresses the rotation of the friction wheel 32. At the same time, when the rotation of the friction wheel 32 is suppressed, the cord tightly wound around the friction wheel 32 does not easily drive the friction wheel 32 to rotate, whereby to resist the movement of the cord, and thereby the frictional resistance could help to counterbalance the weights of the bottom rail 5 and the covering material 7 and the rewinding force from the spiral spring 37, making the bottom rail 5 to stably stay at the predetermined position.

Besides, in another embodiment, if the spring box 50 in the fifth embodiment and the winding method of the cord 2b in the fourth embodiment are arranged in a group, the effect of the frictional resistance in the fourth embodiment could be provided while the cord 2b is being retrieved and released.

When the cord is retrieved (or released), the friction wheel provided in the embodiments of the present invention could be operated to contact the bias member, and thereby the bias member could provide frictional resistance to the friction wheel. Further, the frictional resistance could counterbalance the weights of the bottom rail and the covering material and the rewinding force from the spiral spring, whereby to make the bottom rail of the cordless window covering to stably stay at a predetermined position immediately after an external force is removed. On the other hand, when the cord is released (or retrieved), through the design of the embodiments of the present invention, the bias member provides weaker frictional resistance to the friction wheel, or does not provide a frictional resistance to the friction wheel at all, whereby the bottom rail could be easily moved to unfold (or fold) the covering material.

It must be pointed out that the embodiments described above are only some preferred embodiments of the present invention. All equivalent structures which employ the concepts disclosed in this specification and the appended claims should fall within the scope of the present invention. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A resistance mechanism adapted to provide frictional resistance to a cord of a window covering, wherein, along with a raising and lowering of the window covering, the cord is driven to move in a retrieved direction and a released direction, respectively, the resistance mechanism comprising:
a bias member; and
a resistance assembly adjacent to the cord, wherein a section of the cord corresponding to the resistance assembly is wound around the resistance assembly, so that the resistance assembly is adapted to be operated by the movement of the cord synchronously; the resistance assembly is corresponding to the bias member, and when the cord is moved in the retrieved direction or the released direction, the bias member suppresses a movement of the resistance assembly, and thereby the resistance assembly provides a resistance to the cord;
wherein, when the cord is pulled in the retrieved direction, the bias member provides a first frictional resistance to the resistance assembly; when the cord is pulled in the released direction, the bias member provides a second frictional resistance to the resistance assembly, and the second frictional resistance is different from the first frictional resistance.

2. The resistance mechanism of claim 1, wherein the resistance assembly includes a resistance wheel, and the section of the cord wound around the resistance assembly is tightly wound around the resistance wheel, whereby the resistance wheel is adapted to be driven by the cord to rotate; when the cord is pulled in the retrieved direction, the resistance wheel rotates in a first direction; when the cord is pulled in the released direction, the resistance wheel rotates in a second direction, and the second direction is opposite to the first direction.

3. The resistance mechanism of claim 2, wherein the resistance assembly further includes a base, on which the resistance wheel and the bias member are positioned, and the resistance wheel is able to rotate relative to the base.

4. The resistance mechanism of claim 3, wherein the base has an accommodating space, in which the resistance wheel and the bias member are positioned.

5. The resistance mechanism of claim 4, wherein the bias member and a part of walls of the accommodating space together form a wedge area having a narrow side and a broad side; the resistance wheel is movably positioned in the wedge area, and is operably moved between the narrow side and the broad side.

6. The resistance mechanism of claim 5, wherein when the cord is pulled in the retrieved direction, the resistance wheel is drawn by the cord to move toward the narrow side, and thereby the bias member abuts against the resistance wheel to suppress the rotation of the resistance wheel, whereby to provide the first frictional resistance; when the cord is pulled in the released direction, the resistance wheel is drawn by the cord to move toward the broad side, and at this time, the resistance wheel optionally contacts the bias member, whereby to provide the second frictional resistance, and the second frictional resistance is less than the first frictional resistance.

7. The resistance mechanism of claim 5, wherein when the cord is pulled in the retrieved direction, the resistance wheel is drawn by the cord to move toward the broad side, and at this time, the resistance wheel optionally contacts the bias member, whereby to provide the first frictional resistance; when the cord is pulled in the released direction, the resistance wheel is drawn by the cord to move toward the narrow side, and thereby the bias member abuts against the resistance wheel to suppress the rotation of the resistance wheel, whereby to provide the second frictional resistance; and the second frictional resistance is greater than the first frictional resistance.

8. The resistance mechanism of claim 5, wherein the bias member has a bent section close to the narrow side of the wedge area; when the resistance wheel is pulled by the cord to move toward the narrow side, the bent section of the bias abuts against the resistance wheel, so as to suppress the rotation of the resistance wheel, and thereby the rotation speed of the resistance wheel becomes slower.

9. The resistance mechanism of claim 5, wherein the bias member has an abutting portion optionally abutting one of the walls of the accommodating space; the bias member comprises a free end, which is not at the abutting portion, and is close to the broad side of the wedge area.

10. The resistance mechanism of claim 4, wherein the bias member comprises a constraint portion and an abutting portion; the abutting portion abuts against a wall of the accommodating space, and the constraint portion is drivable by the abutting portion to optionally release or grip the resistance wheel, whereby to allow or disallow the resistance wheel to rotate relative to the constraint portion.

11. The resistance mechanism of claim 10, wherein a winding direction of the constraint portion of the bias member around the resistance wheel is same as a winding direction of the cord around the resistance wheel; when the cord is pulled in the retrieved direction, the resistance wheel is driven to rotate in the first direction, and the abutting portion of the bias member would abut against the wall, so that the bias member cannot move; at this time, the rotation of the resistance wheel makes the constraint portion to be slightly released, and therefore the resistance wheel is rotatable relative to the bias member, whereby the constraint portion provide the first frictional resistance to the resistance wheel, suppressing the rotation of the resistance wheel; when the cord is pulled in the released direction, the resistance wheel is driven by the cord to rotate in the second direction, and the constraint portion grips the resistance wheel, so that the resistance wheel drives the bias member to rotate together; at this time, the abutting portion of the bias member is driven to optionally rub the wall of the base, whereby the bias member optionally provides the second frictional resistance to the base, and the second frictional resistance is less than the first frictional resistance.

12. The resistance mechanism of claim 10, wherein a winding direction of the constraint portion of the bias member around the resistance wheel is opposite to a winding direction of the cord around the resistance wheel; when the cord is pulled in the retrieved direction, the resistance wheel is driven to rotate in the first direction, and the bias member grips the resistance wheel, so that the resistance wheel drives the bias member to rotate together; at this time, the abutting portion of the bias member is driven to optionally rub the wall of the base, whereby the bias member optionally provides the first frictional resistance to the base; when the cord is pulled in the released direction, the resistance wheel is driven by the cord to rotate in the second direction, and the abutting portion of the bias member abuts against the wall, so that the bias member cannot move; at this time, the rotation of the resistance makes the constraint portion to be slightly released, and therefore the resistance wheel is rotatable relative to the bias member, whereby the constraint portion provide the second frictional resistance to the resistance wheel, suppressing the rotation of the resistance wheel, and the second frictional resistance is greater than the first frictional resistance.

13. The resistance mechanism of claim 10, wherein the bias member is a coiled spring, and a diameter of the constraint portion is less than a diameter of the abutting portion.
